(19) United States
(12) Patent Application Publication
(10) Pub. No.: US 2023/0043426 A1
(43) Pub. Date: Feb. 9, 2023

(54) CONNECTING PART FOR A PLUG-IN CONNECTION SYSTEM

(71) Applicant: era-contact GmbH, Bretten (DE)

(72) Inventors: Michael-Edgar Luppold, Dettenheim (DE); Dietmar Metzger, Knittlingen (DE); Dietmar Kapp, Herrenberg (DE); Uwe Kammerer, Stutensee (DE); Patrick Bollig, Mühlacker (DE); Sven Wachter, Bretten (DE)

(73) Assignee: era-contact GmbH, Bretten (DE)

(21) Appl. No.: 17/792,616

(22) PCT Filed: Jan. 14, 2021
(86) PCT No.: PCT/EP2021/050619

§ 371 Date: Oct. 31, 2022

(30) Foreign Application Priority Data
Jan. 14, 2020 (DE) 10 2020 100 682.9

(51) Int. Cl. H01R 13/52; H01R 13/516

(52) U.S. Cl. CPC H01R 13/5219; H01R 13/5213; H01R 13/516; H01R 2201/26

(57) ABSTRACT

Described is a connecting part for a plug-in connection system of a coupling device for automatically coupling a trailer vehicle to a towing vehicle, comprising: a contact carrier, a contact structure mounted on the contact carrier and engageable with a contact structure of a complementary connecting part of the plug-in connection system to establish a plug-in connection with the complementary connecting part during automatic coupling, a closure flap pivotable relative to the contact carrier, which is biased onto the contract carrier and is releasable from the contact carrier in a pivoting movement against this bias when the plug-in connection is established, and a seal which is arranged on the contact carrier and is elastically deformable by a counterpart pressing on the seal in order to seal the contact structure with respect to the exterior space, wherein the counterpart is formed by the closure flap pressing on the seal when the plug-in connection is disconnected and by the complementary connecting part of the plug-in connection system pressing on the seal when the plug-in connection is established, characterized in that the contact carrier comprises at least one sealing groove enclosing the contact structure and the seal is formed of at least one sealing lip which is inserted into the sealing groove and has a sealing profile which is inclined toward a side facing away from the contact structure, so that the sealing lip deforms elastically toward this side when the counterpart presses on the sealing lip.

### CROSS-REFERENCE TO RELATED APPLICATION

This application is a National Phase of International Application No. PCT/EP2021/050619, filed Jan. 14, 2021, which claims the benefit of German Application 10 2020 100 682.9, filed Jan. 14, 2020, both of which are incorporated herein in their entireties.

### TECHNICAL FIELD

The invention relates to a connecting part for a plug-in connection system of a coupling device for automatically coupling a trailer vehicle to a towing vehicle, comprising a contact carrier, a contact structure which is attached to the contact carrier and is engageable with a contact structure of a complementary connecting part of the plug-in connection system in order to establish a plug-in connection with the complementary connecting part during automatic coupling, a closure flap which is pivotable relative to the contact carrier, is biased onto the contact carrier and is releasable from the contact carrier in a pivoting movement against this bias when the plug-in connection is established, and a seal which is arranged on the contact carrier and is elastically deformable by a counterpart pressing on the seal for sealing the contact structure with respect to the exterior space, the counterpart being formed by the closure flap pressing on the seal when the plug-in connection is disconnected and by the complementary connecting part of the plug-in connection system pressing on the seal when the plug-in connection is established. The invention further relates to a plug-in connection system for a coupling device for automatically coupling a trailer vehicle to a towing vehicle.

### BACKGROUND

In the commercial vehicle sector, coupling devices are known that serve to automatically couple a trailer vehicle to a towing vehicle. A semitrailer, for example, usually has a pin arranged on its underside that can be positively locked in a fifth wheel coupling of a tractor. In addition to this mechanical coupling, a plug-in connection system is also provided to supply the trailer vehicle with electrical power and/or compressed air. It is also possible to transmit electrical and/or optical control signals between the tractor and the semitrailer via such a plug-in connection system. Plug-in connection systems of this type are known, for example, from documents DE 10 2008 014 285 A1 and DE 10 2008 014 572 B4.

Accordingly, such a plug-in connection system is formed by two associated connecting parts, one of which is mounted on the towing vehicle and the other on the trailer vehicle. Each of these connecting parts has a contact carrier as well as a plurality of contact elements mounted thereon, which come into engagement in pairs with the contact elements of the respective other connecting part assigned to them when the trailer vehicle is coupled to the towing vehicle. As a rule, the contact elements provided on one connecting part are designed as plugs, while the contact elements of the other connecting part form complementary sockets. As the plugs engage with their associated sockets, the plug-in connections required for the supply of electrical power, electrical and/or optical control signals and compressed air are established between the two connecting parts.

To protect the contact structure formed by the contact elements from environmental influences such as water, dust, etc., the connecting part has a closure flap which is pivotably mounted on the contact carrier and is biased in the direction of the contact carrier, for example by means of a spring. In the uncoupled state, the closure flap presses on a seal attached to the contact carrier. This seal is made of an elastic material so that it deforms when the spring-loaded closure flap presses on the seal. In the coupled state, in which the plug-in connection is established between the two connecting parts forming the plug-in connection system, a suitable mechanism ensures in the interaction of the two connecting parts that the closure flap is pivoted away from the seal against the biasing force. In this state, the other connecting part of the plug-in connection system presses on the seal, thus sealing the contact elements brought into engagement with each other in a fluid-tight manner against the exterior space.

In the prior art, the seal is formed from a sealing plate, which merges in one piece into individual sealing lips, each of which encloses one of the contact elements in an annular shape. A further circumferential sealing lip is formed at the edge of the sealing plate and encloses the contact structure formed by the contact elements as a whole. The individual sealing lips each have a sealing profile in the form of a simple elevation extending in a direction perpendicular to the plane of the plate. Thus, the sealing lip is pressurized by the respective sealing counterpart, i.e. in the uncoupled state by the closure flap and in the coupled state by the complementary connecting part, in a direction that coincides with the direction in which the sealing lip projects from the plate plane.

With regard to the sealing capacity of such a seal, it must be taken into account that a certain compression set occurs with common sealing materials, which is a measure of how much time the sealing material requires to return to its original geometry after deformation under pressure. In the present context, it should also be taken into account that the plug-in connection system exerts significantly different pressing forces on the seal in the coupled and uncoupled states. In the uncoupled state, for example, the closure flap biased onto the seal exerts a significantly lower pressing force on the seal than the complementary connecting part of the plug-in connection system does, for example via pneumatic actuations, in the coupled state. Accordingly, after a certain time in the coupled state, the seal also needs significantly longer to return to its initial geometry than is the case from the uncoupled state. This can mean that the pressing force subsequently exerted on the seal by the biased closure flap in the coupled state is not sufficient to ensure adequate sealing of the contact structure against the exterior space. This means that water or dust can enter the area of the contact structure and contaminate or even damage it.

To achieve the desired tightness, it could be considered to increase the biasing force with which the closure flap is pressed onto the seal in the uncoupled state. However, this would mean that the force opposing the bias, which has to be provided when establishing the plug-in connection to open the closure flap, would be correspondingly large. The mechanisms currently used to open the closure flap might then no longer be suitable and would have to be retrofitted or replaced, which should be avoided in view of the costs involved.

### SUMMARY

It is the object of the present invention to specify a connecting part provided for a plug-in connection system of a coupling device, which enables an improved sealing effect with little technical effort. Furthermore, it is the object of the invention to provide a plug-in connection system with such a connecting part.

The afore-mentioned objects are solved by the connecting part according to claim 1 and the plug-in connection system according to claim 15. Advantageous embodiments result from the dependent claims and the following description.

The connecting part according to the invention comprises a contact carrier, a contact structure which is attached to the contact carrier and is engageable with a contact structure of a complementary connecting part of the plug-in connection system in order to establish a plug-in connection with the complementary connecting part during automatic coupling, a closure flap which is pivotable relative to the contact carrier, is biased onto the contract carrier and is releasable from the contact carrier in a pivoting movement against this bias when the plug-in connection is established, and a seal which is arranged on the contact carrier and, in order to seal the contact structure with respect to the exterior space, is elastically deformable by a counterpart pressing on the seal, the counterpart being formed by the closure flap pressing on the seal when the plug-in connection is disconnected and by the complementary connecting part of the plug-in connection system pressing on the seal when the plug-in connection is established. The contact carrier has at least one sealing groove enclosing the contact structure. The seal is formed from at least one sealing lip, which is inserted into the sealing groove and thus encloses the contact structure. The sealing lip has a sealing profile which is inclined towards a side facing away from the contact structure, so that the sealing lip deforms elastically toward this side when the counterpart presses on the sealing lip.

In contrast to conventional seals, whose sealing lips form elevations projecting perpendicularly from the contact carrier, the sealing lip according to the invention has a sealing profile which is asymmetrical and undercut, so to speak, in such a way that the profile section projecting from the contact carrier is inclined outwards, i.e. away from the contact structure enclosed by the sealing lip, relative to the surface normal of the contact carrier. This means that in the present invention, in contrast to the prior art, the direction in which the sealing lip rises starting from the contact carrier does not coincide with the direction of the compressive load exerted on the sealing lip by the sealing counterpart, i.e. in the uncoupled state by the spring-biased closure flap. This means that the sealing profile of the sealing lip, which in this case means the cross-section through the sealing lip, springs away outwards as a result of the pressure load, which provides various advantages over conventional sealing geometries.

This means that the sealing material is subjected to less stress as a result of the sealing lip sliding away than in a case where the direction of extension of the sealing profile coincides with the direction of pressurization. On the one hand, this results in a longer service life of the seal. On the other hand, there is a reduction in the compression set, so that the sealing lip returns to its original shape quicker after being subjected to a high compressive load in the coupled state. This ensures, particularly in the period immediately after the plug-in connection is disconnected, that the closure flap, which acts on the seal with a significantly lower pressing force, also provides a reliable seal of the contact elements against the exterior space. Furthermore, the sealing profile according to the invention is selected in such a way that when the plug-in connection is disconnected, splash water directed at the connecting part acts from outside on the sealing lip, which is elastically deformed toward the outside, as a result of which the sealing lip is pressed even stronger against the closure flap by the water. This also increases the sealing effect of the connecting part according to the invention in the uncoupled state.

The seal according to the invention preferably consists exclusively of the at least one sealing lip, which is fastened in the associated sealing groove formed in the contact carrier, for example by injection molding. In other words, with the exception of one or more sealing lips, the seal does not have any other sealing structures, such as a sealing plate used in the prior art. This ensures that the pressure area is defined essentially by the length of the sealing lip alone (or by the summed length when several sealing lips are used). For a given pressing force with which the closure flap acts on the seal, this results in an increased surface or line pressure on the sealing edge, which further increases the sealing effect. In particular, a comparatively moderate bias of the closure flap can be used to achieve the desired sealing effect. When coupling the trailer vehicle to the towing vehicle, this makes it easier to open the closure flap against the biasing force with which the closure flap presses onto the seal.

Preferably, the sealing lip has a profiled section projecting from the contact carrier, which tapers with increasing distance from the contact carrier. This allows the sealing edge formed by the free end of the profile section to be kept narrow to increase the surface pressure. In addition, the taper makes the sealing lip more movable. At the same time, the taper causes the sealing lip to be reinforced in accordance with the bending moment curve. This means that the sealing lip is comparatively thin at its tip, i.e. in the area of its sealing edge where a lower bending moment acts, and thicker toward the contact carrier where a higher bending moment acts.

In a preferred embodiment, the sealing lip has a profile section projecting from the contact carrier, which has a first profile side facing the contact structure and a second profile side facing away from the contact structure, which each have an inclination directed away from the contact structure, the inclination of the first profile side being greater than the inclination of the second profile side. In this way, it is ensured that the sealing edge formed by the free end of the profile section has a greater distance from the contact structure in the projection onto the contact carrier than a base point of the second profile side, which is defined by the end of the second profile side opposite the sealing edge on the plate plane. A pressing force acting on the sealing edge thus reliably ensures that the sealing profile springs outwards away from the contact structure.

For example, the profile section projecting from the contact carrier has essentially the shape of an oblique triangle. However, it goes without saying that a sealing geometry deviating from this can also be selected, provided that such a geometry achieves elastic deformation in the desired direction, i.e. in a direction pointing away from the contact structure.

Preferably, the sealing groove defines a first groove space given by a recess formed in the contact carrier, and a second groove space which adjoins the first groove space and is widened relative to the first groove space. In this embodiment, the sealing lip may have a sealing seat that is fixed in the first groove space, while the profile section of the sealing lip that adjoins the sealing seat is elastically deformable in the widened second groove space. The second groove space defined by the sealing groove provides the sealing lip with sufficient space to avoid the compressive load so to speak by moving sideways, without damaging the sealing lip.

The above-mentioned two-stage design of the sealing groove is to be understood merely as an example. In particular, a single-stage design of the sealing groove is also possible, i.e. a design in which two differently sized groove spaces of the type explained above are dispensed with.

In a special embodiment, several contact elements forming the contact structure can be enclosed by a single sealing lip. Alternatively, it is also possible to use several sealing lips, each of which then encloses a part of the contact elements.

The contact elements are designed as plug-in connection elements, which can be engaged in pairs with their respective associated plug-in connection elements of the contact structure of the complementary connecting part in order to establish the plug-in connection. The respective plug-in connection element can be designed as a plug or socket. In this connection, all plug-in connection elements are preferably provided either in the form of a plug or a socket on the connecting part considered here. Accordingly, the contact elements of the other connecting part are designed in the respective complementary form in order to provide the desired plug-in connections.

The sealing lip is preferably made of an elastic plastic, e.g. an elastomer or a silicone. Based on such a material, the sealing lip can be manufactured, e.g. by injection molding, in the desired design, in particular with the desired elasticity.

Preferably, the connecting part comprises a biasing device which is designed to press the closure flap onto the sealing lip when the plug-in connection is disconnected and to pivot the closure flap away from the sealing lip in cooperation with the complementary connecting part when the plug-in connection is established. Such a biasing device has, for example, one or more spring elements by means of which the closure flap is biased onto the contact carrier so that, in the disconnected state, the closure flap presses with the desired pressing force on the seal fitted in the contact carrier.

Another aspect of the invention provides a plug-in connection system for a coupling device for automatically coupling a trailer vehicle to a towing vehicle. The plug-in connection system comprises a first connecting part of the type described above, and a complementary second connecting part having a contact structure engageable with the contact structure of the first connecting part to establish a plug-in connection with the first connecting part during automatic coupling.

### BRIEF DESCRIPTION OF THE DRAWINGS

The invention is explained in more detail below with reference to the figures.

FIG. 1 shows a perspective view of a connecting part of a plug-in connection system according to an embodiment with open closure flap.

FIG. 2 shows a perspective view of the connecting part with the closure flap closed.

FIG. 3 shows a perspective view showing the closure part according to FIGS. 1 and 2 together with a complementary connecting part of the plug-in connection system when the plug-in connection is disconnected.

FIG. 4 shows a perspective view showing the two connecting parts according to FIG. 3 with the plug-in connection established.

FIG. 5 shows a perspective view of two sealing lips according to an embodiment.

FIG. 6 shows a cross-section through a sealing lip to illustrate the sealing profile.

FIG. 7 shows a sectional view through the two connecting parts forming the plug-in connection system in a state in which the plug-in connection has not yet been fully established.

FIG. 8 shows a detailed view of the illustration in FIG. 7 to illustrate the sealing profile with the plug-in connection not yet completely established.

FIG. 9 shows a sectional view of the two connecting parts forming the plug-in connection system in a state in which the plug-in connection is fully established, and

FIG. 10 shows a detailed view of the illustration of FIG. 9 to illustrate the sealing profile when the plug-in connection is fully established.

### DETAILED DESCRIPTION

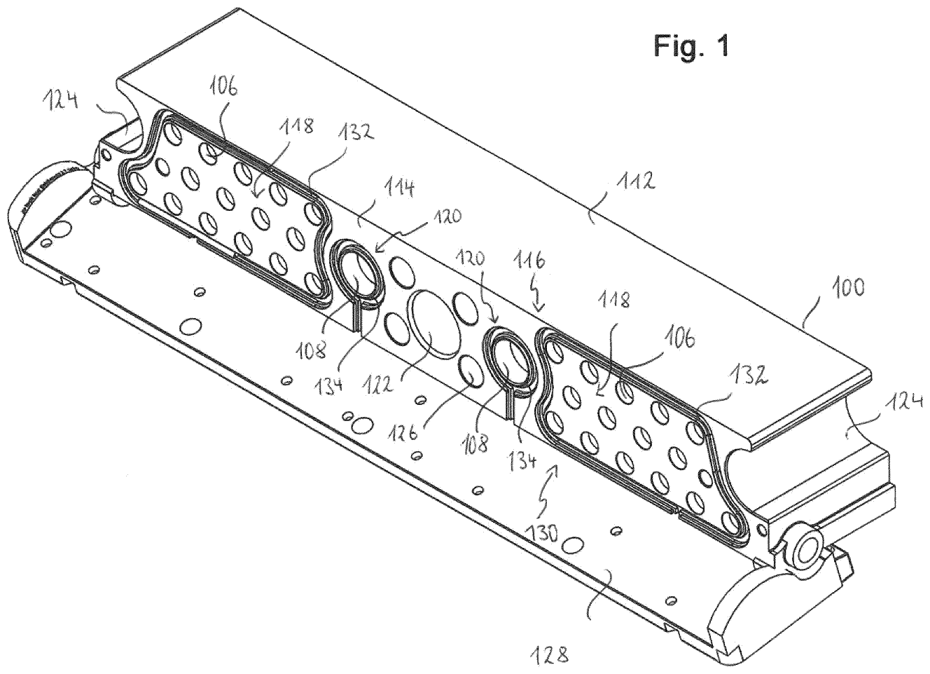

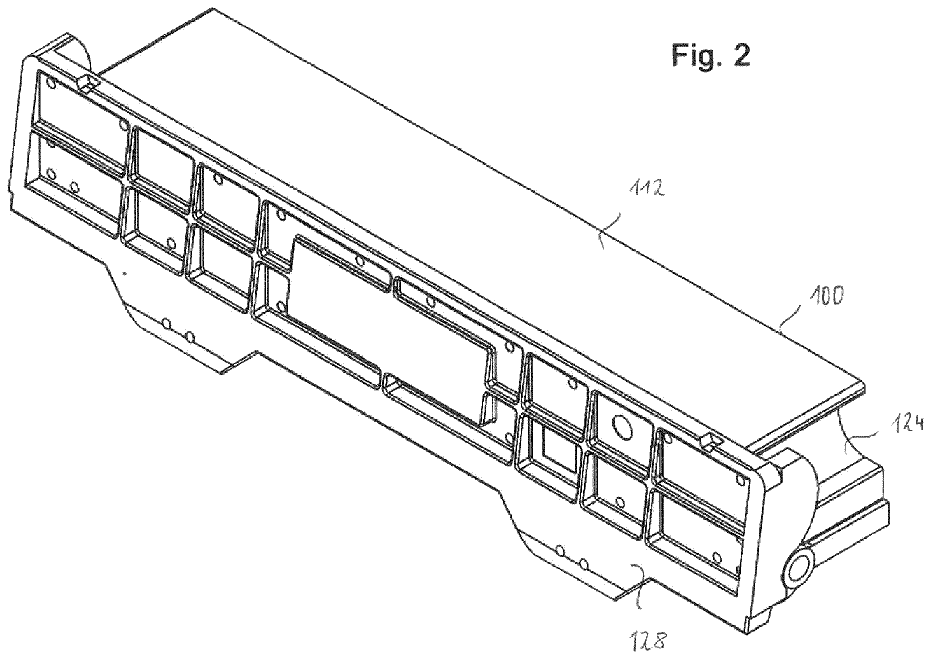

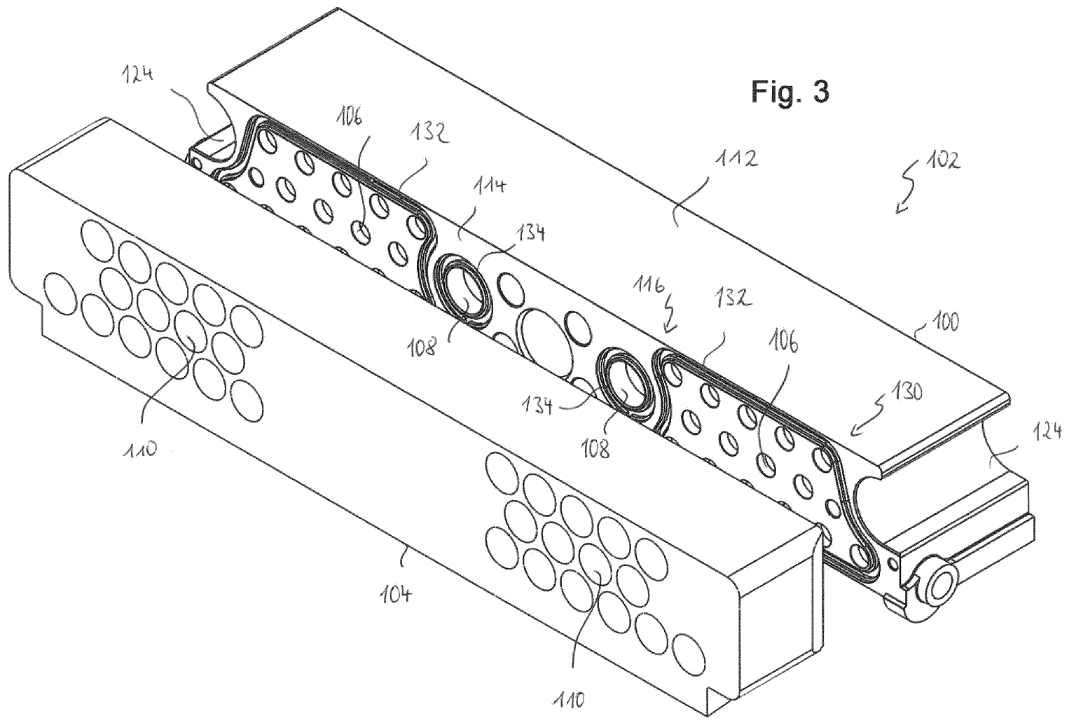

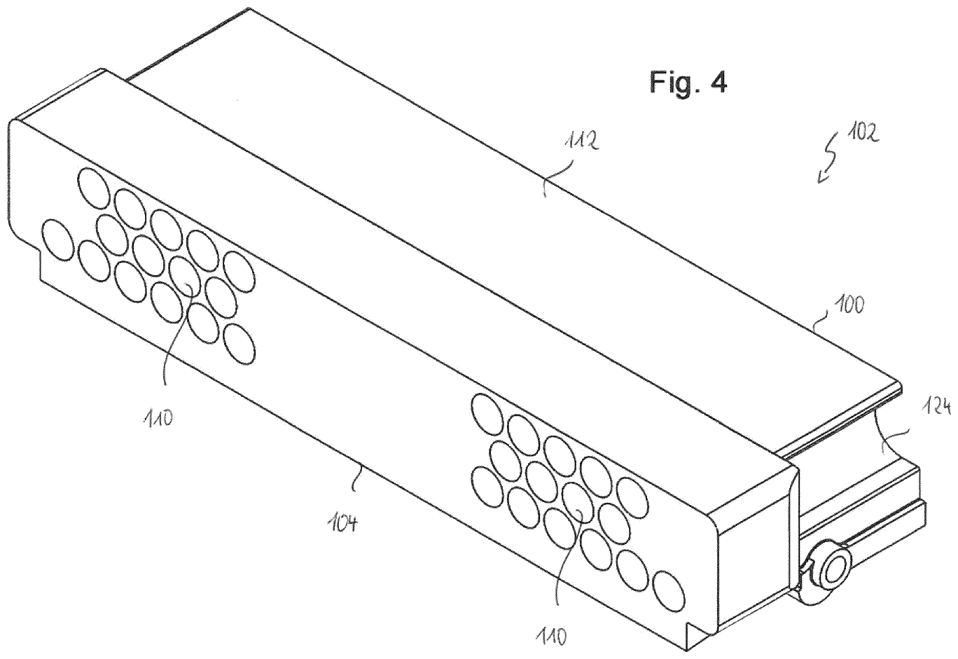

In FIGS. 1 and 2, a connecting part 100 according to the invention is shown as an embodiment, which is part of a plug-in connection system 102. The latter is in turn provided in a coupling device used to couple a trailer vehicle, for example a semi-trailer, to a towing vehicle. In addition to the connecting part 100 shown in FIGS. 1 and 2, the plug-in connection system 102 includes a complementary connecting part 104, as shown in FIGS. 3 and 4. In the present example, the connecting part 100 shown in FIGS. 1 and 2 is intended to be mounted on the towing vehicle, while the other connecting part is provided on the trailer vehicle. However, it is likewise possible to provide an interchanged arrangement of the two connecting parts 100, 104 for this purpose.

The two connecting parts 100, 104 forming the plug-in connection system 102 are used to transmit electrical power, compressed air and electrical and/or optical control signals between the towing vehicle and the trailer vehicle. For this purpose, the two connecting parts 100, 104 each have a plurality of contact elements which are brought into engagement with one another in pairs when the trailer vehicle is coupled to the towing vehicle. The contact elements, which are assigned to each other in pairs, are each designed in the form of a plug and a socket in order to establish the desired plug-in connection during the coupling process.

At this point it should be noted that in FIGS. 1 to 4, to simplify the illustration, the afore-mentioned contact elements themselves are blanked out and are shown only by means of recesses 106, 108 or 110 in which the contact elements are accommodated. When the contact elements 106, 108, 110 are referred to in the following, reference is therefore made to these recesses. The contact elements of the complementary connecting part 104 associated with the contact elements 108 of the connecting part 100 are not shown in FIGS. 3 and 4.

For the embodiment shown in FIGS. 1 to 4, it can be assumed by way of example that the contact elements 106, 108 provided on the connecting part 100 mounted on the towing vehicle are designed as sockets. Accordingly, the contact elements 110 of the connecting part 104 mounted on the trailer vehicle, which are complementary thereto, are designed as plugs. However, it is likewise possible to provide the plugs and the sockets in an interchanged arrangement for this purpose. An arrangement distributed over both connecting parts 100, 104, in which each connecting part 100, 104 has both plugs and sockets, is also conceivable.

Referring now to FIGS. 1 and 2, the connecting part 100 mounted on the towing vehicle in the present embodiment will be described in more detail. The connecting part 100 includes a housing 112 and a contact carrier 114 mounted to the housing 112. Attached to the contact carrier 114 is a contact structure generally designated 116, which is formed by the afore-mentioned contact elements 106, 108.

In the embodiment shown, the contact structure 116 comprises two contact units 118 arranged in mirror symmetry with respect to a vertical central axis, which are used, for example, to transmit electrical signals between the two connecting parts 100, 104. These two functional units 118 are formed by the contact elements 106. Furthermore, the contact structure 116 comprises two functional units 120, also arranged mirror-symmetrically on the contact carrier 114, for transmitting compressed air. These pneumatic functional units 120 are formed by the contact elements 108.

The contact carrier 114 further has a centering opening 122 in its central region, into which a matching centering rod (not shown), which is attached to the other connecting part 104, is inserted during the coupling process. The centering opening 122 and the associated centering rod have the function of aligning the two connecting parts 100, 104 in the correct position relative to one another, so that the contact elements 106, 108 of the connecting part 100 engage with the contact elements of the complementary connecting part 104 assigned to them in a precisely fitting manner. The same function is served by two recesses 124 formed on opposite sides of the housing, which cooperate during the coupling process with two matching guide rods (not shown) provided on the complementary connecting part 104. FIG. 1 further shows four mounting holes 126 around the centering opening, but these are not further relevant for the understanding of the embodiment of the invention.

The connecting part 100 further comprises a closure flap 128 which serves to protect the contact carrier 114 and in particular the contact elements 106, 108 attached thereto from environmental influences such as dust and splash water. For this purpose, the closure flap 128 is mounted on the housing 112 in such a way that it can be pivoted from an open position as shown in FIG. 1 to a closed position as shown in FIG. 2. To ensure closure of the contact carrier 114 in the uncoupled state, the closure flap 128 is biased onto the contact carrier 114 by means of a biasing device. This biasing device comprises, for example, two tension springs not shown in FIGS. 1 and 2, which are arranged on both sides of the housing 112 and pull the closure flap 128 in the direction of the contact carrier 114. The biasing device is further designed to cooperate in a manner known per se with the complementary connecting part 104 in such a way that the closing flap 128 (cf. FIG. 2), which is initially closed during coupling, is opened against the biasing force by being released from the contact carrier 114 in a pivoting movement (cf. FIG. 1).

As shown in FIG. 1, a seal generally designated 130 is arranged on the contact carrier 114, which in the present embodiment comprises two first sealing lips 132 arranged mirror-symmetrically with respect to each other and two second sealing lips 134 also arranged mirror-symmetrically with respect to each other. The sealing lips 132, 134 are designed in such a way that they enclose the contact structure 116 formed by the contact elements 106, 108 in their entirety. In this case, the electrical contact elements 106 are enclosed by the two first sealing lips 132 and the two pneumatic contact elements 108 are enclosed by the two second sealing lips 134.

The seal composed of the sealing lips 132, 134 serves to seal the contact elements 106, 108 in a fluid-tight and a dust-tight manner from the exterior space both in the uncoupled and in the coupled state, for example to protect the contact elements 106, 108 from dust and splash water. For this purpose, the seal 130 cooperates with a counterpart formed by the closure flap 128 in the uncoupled state and by the complementary connecting part 104 in the coupled state. In both states, in fact, the respective counterpart presses on the seal 130 and thus provides the desired seal.

As mentioned further above, the pressing force which the closure flap 128 exerts on the seal 130 in the uncoupled state is significantly less than the pressing force with which the complementary connecting part 104 presses on the seal 130 in the coupled state. For this reason, as will be explained further on, the present invention aims in particular at configuring the seal 130 composed of the sealing lips 132, 134 in an advantageous manner in such a way that the seal 130 achieves a reliable sealing of the contact structure 116 not only in cooperation with the complementary connecting part 104, but also in cooperation with the closure flap 128 exerting only a comparatively low pressing force.

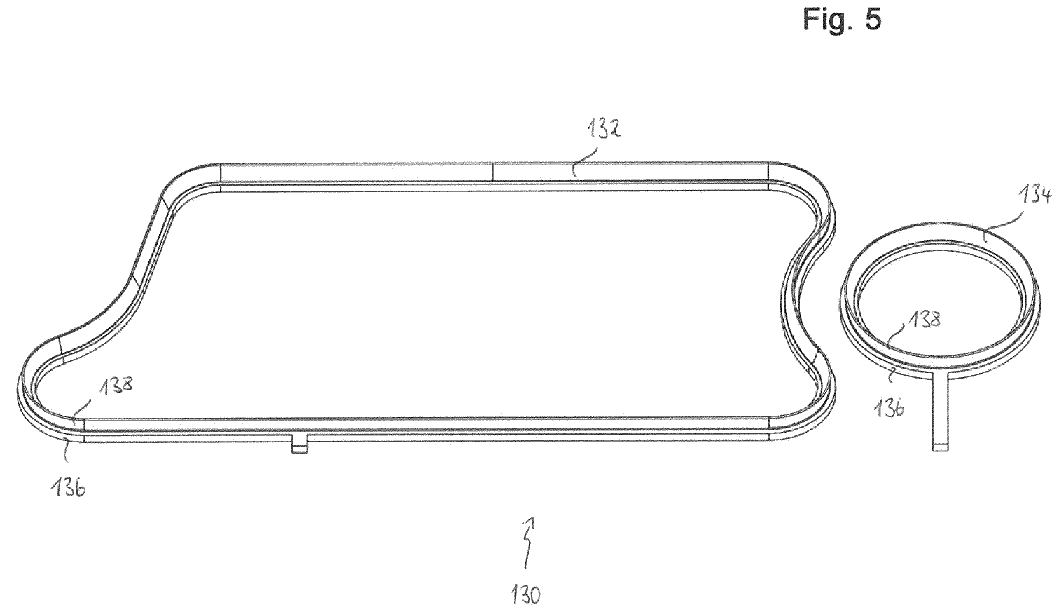

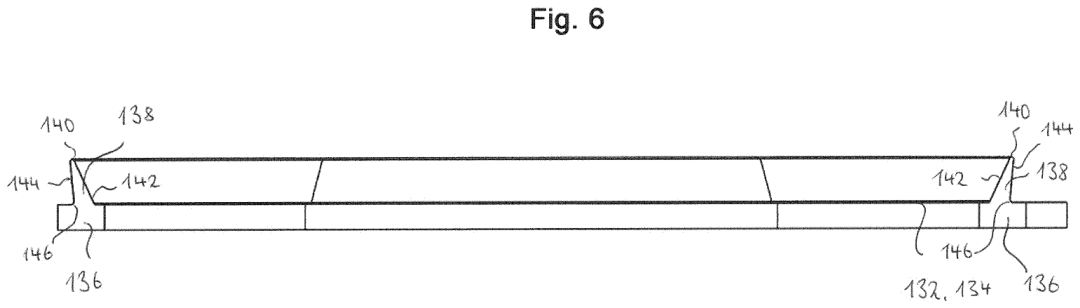

In FIG. 5, the first sealing lip 132 and the second sealing lip 134, which are each provided in duplicate in the present embodiment (cf. FIG. 1), are shown in perspective all alone. FIG. 6 shows a cross-sectional view of the respective sealing lip 132, 134.

As shown in FIG. 5, the two sealing lips 132, 134 each have a closed shape in order to completely enclose the contact elements 106, 108 associated with them. The two sealing lips 132, 134 differ from each other in their contour, i.e. in the course in which they are guided around the contact elements 106, 108 associated with them. These different contours are due to the arrangement of contact elements 106, 108 selected in each case and are to be understood purely as examples. What the two sealing lips 132, 134 have in common, however, is their property of deforming elastically in a direction pointing away from the respective enclosed contact structure when pressure is applied by the respective counterpart, i.e. the closure flap 128 or the complementary connecting part 104.

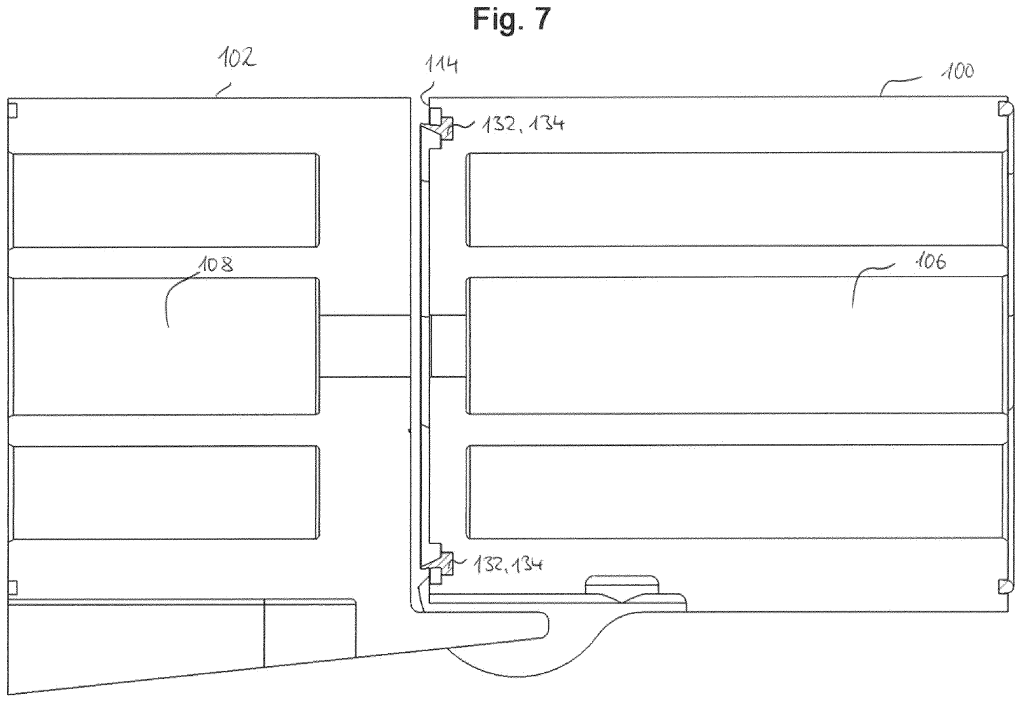

This sealing profile, directed away from the contact structure, is best seen in FIG. 6. Its mode of action during the coupling process is illustrated in FIGS. 7 to 10.

As shown in FIG. 6, the sealing lip 132, 134 has a sealing seat 136 attached to the contact carrier 114. This sealing seat is adjoined by a profile section 138 that projects from the sealing seat 136 and thus from the contact carrier 114. In the embodiment shown, the protruding profile section 138 tapers towards its free end, which forms a sealing edge 140. The latter first comes into contact with the respective sealing counterpart, i.e. during coupling with the complementary connecting part 104 and during uncoupling with the closure flap 128. The profile section 138 projecting from the contact carrier 114 is inclined outwardly away from the enclosed contact elements 106, 108. In the specific embodiment shown in FIG. 6, the profile section 138 has an inner first profile side 142 and an outer second profile side 144, both of which are inclined outwardly. The inner profile side 142 is more inclined outwardly than the outer profile side 144. Accordingly, the sealing edge 140 formed by the free end of the profile section 138 is located further outward in the longitudinal sectional view of FIG. 6 than a base point 146 located at the junction between the sealing seat 136 attached to the contact carrier 114 and the outer profile side 144 of the profile section 138. Thus, in the configuration shown in FIG. 6, the profile section 138 is substantially in the shape of an oblique triangle.

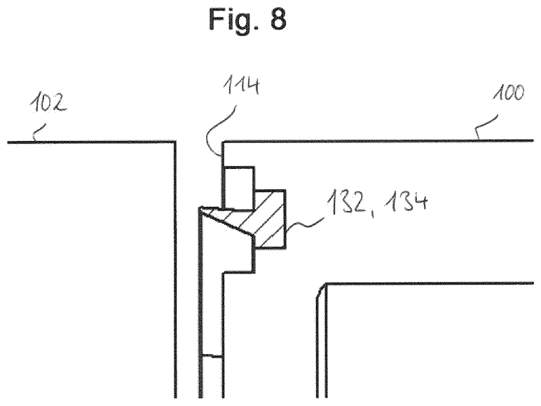

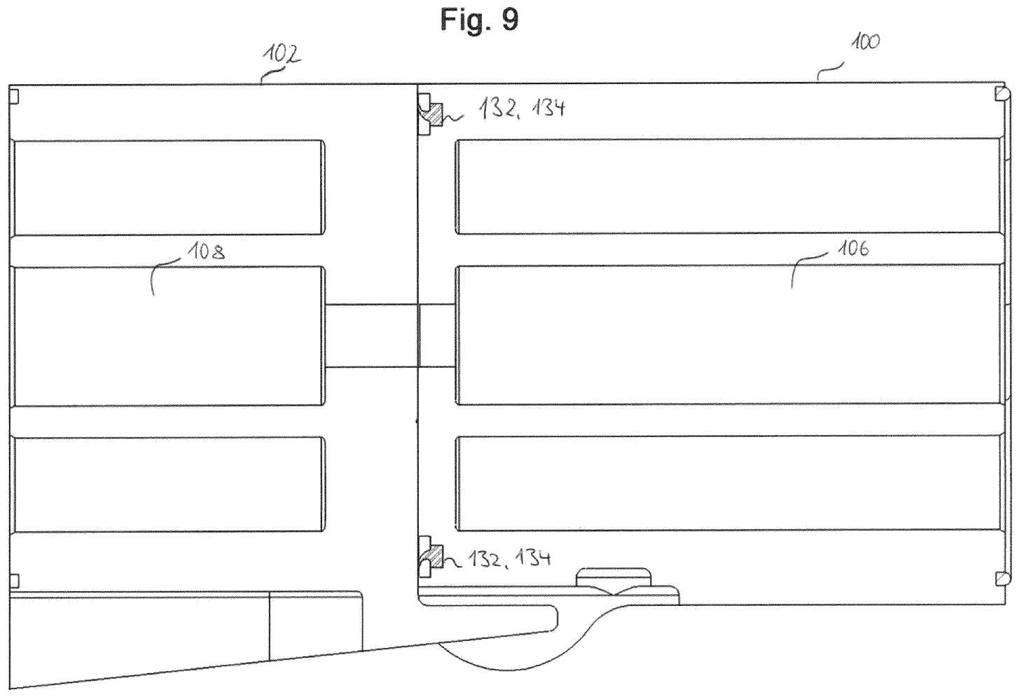

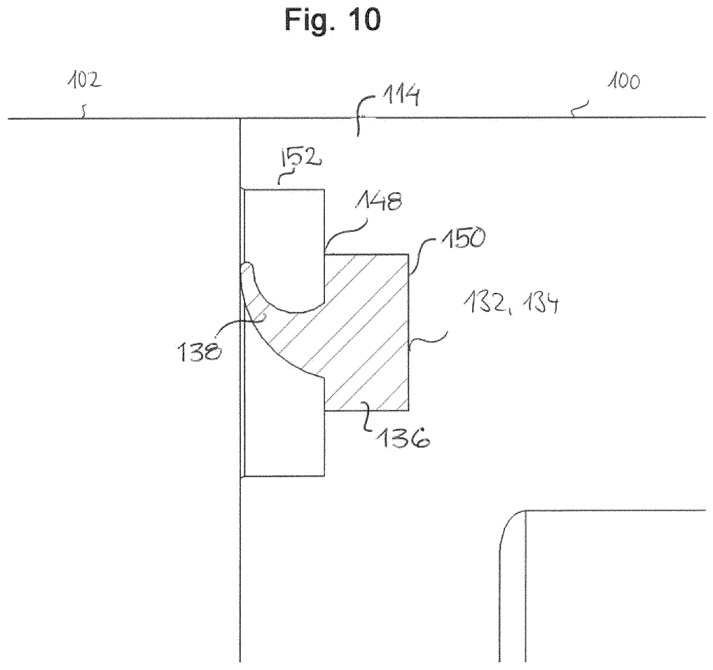

The sectional view according to FIG. 7 and the detailed view derived therefrom according to FIG. 8 show a state in which the two connecting parts 100, 104 are still at a distance from each other in the plug-in direction during the coupling process, in which the sealing lip 132, 134 shown is just still unimpacted by the connecting part 104 forming the sealing counterpart. In contrast, the sectional view 9 and the detailed view derived therefrom according to FIG. 10 show the fully coupled state in which the complementary connecting part 104 presses on the sealing lip 132, 134. As shown in FIGS. 9 and 10, the pressing force exerted by the complementary connecting part 104 causes the sealing profile to spring outwards away from the enclosed contact structure and to abut the end face of the connecting part 104 with the inner profile side 142 of the profile section 138 (cf. FIG. 6). As a result, the contact elements 106, 108, which are arranged within the two sealing lips shown in FIGS. 9 and 10, are sealed from the exterior space in a fluid- and dust-tight manner.

The sealing geometry according to the invention is selected so that the direction in which the sealing profile extends away from the contact carrier 114 does not coincide with the direction of pressurization, but is inclined outwardly relative to this direction. This counteracts material fatigue that would otherwise occur over a large number of coupling operations. In addition, this advantageously leads to a reduction in the compression set after the plug-in connection is disconnected, so that subsequently the pressing force exerted by the closure flap 128 on the seal 130 is sufficient to achieve the desired seal.

The detailed view according to FIG. 10 further shows that a sealing groove 148 of stepped cross-section is provided in the contact carrier 114 for attaching the sealing lip 132, 134. It goes without saying that the sealing groove 148 in the contact carrier 114 has a course which corresponds to the course of the sealing lip 132, 134, which is to be fixed in the sealing groove 148, for example by injection molding. The sealing groove 148 defines a first groove space 150 and a second groove space 152, which is adjacent thereto in the axial direction and is widened relative to the first groove space 150. The first groove space 150 serves to secure the sealing seat 136 of the sealing lip 132, 134. In contrast, the widened second groove space 152 has the function of providing sufficient space for the profile section 138 of the sealing lip 132, 134 adjoining the sealing seat 136 to elastically deform when the complementary connecting portion 104 presses on the sealing lip 132, 134 in a fully coupled state. In this manner, the sealing groove 148 of the sealing lip 132, 134 provides sufficient opportunity to avoid the pressurization by lateral deflection, by way of elastic deformation, without causing damage to the sealing lip 132, 134.

With reference to the detailed view according to FIG. 10, a further advantage of the sealing geometry according to the invention is that splash water acting on the plug-in connection system 104 from the outside presses the elastically deformed sealing lip 132, 134 against the respective sealing counterpart, which even increases the sealing effect. In this connection, it should be noted that the detailed view according to FIG. 10 does indeed refer to the situation illustrated in FIG. 9, in which the sealing counterpart is formed by the complementary connecting part 104. However, it is understood that the foregoing explanations apply in the same manner in the case where the sealing counterpart is formed by the closure flap 128.

1. A connecting part (100) for a plug-in connection system (102) of a coupling device for automatically coupling a trailer vehicle to a towing vehicle, comprising:
a contact carrier (114),
a contact structure (116) which is attached to the contact carrier (114) and is engageable with a contact structure of a complementary connecting part (104) of the plug-in connection system (102) to establish a plug-in connection with the complementary connecting part (104) during automatic coupling,
a closure flap (128) which is pivotable relative to the contact carrier (114), is biased onto the contract carrier (114) and is releasable from the contact carrier (114) in a pivoting movement against this bias when the plug-in connection is established, and
a seal (130) which is arranged on the contact carrier (114) and is elastically deformable by a counterpart pressing on the seal (130) for sealing the contact structure (116) with respect to the exterior space,
wherein the counterpart is formed by the closure flap (128) pressing on the seal (130) when the plug-in connection is disconnected and by the complementary connecting part (104) of the plug-in connection system (102) pressing on the seal (130) when the plug-in connection is established,
characterized in that the contact carrier (114) has at least one sealing groove (148) surrounding the contact structure (116), and the seal (130) is formed from at least one sealing lip (132, 134) which is inserted into the sealing groove (148) and has a sealing profile which is inclined toward a side facing away from the contact structure (116), so that the sealing lip (132, 134) deforms elastically toward this side when the counterpart presses on the sealing lip (132, 134).

2. The connecting part (100) according to claim 1, characterized in that the sealing lip (132, 134) has a profile section (138) projecting from the contact carrier (114), which tapers with increasing distance from the contact carrier (114).

3. The connecting part (100) according to claim 1 or 2, characterized in that the sealing lip (132, 134) has a profile section (138) projecting from the contact carrier (114), which profile section has a first profile side (142) facing the contact structure (116) and a second profile side (144) facing away from the contact structure (116), which profile sides each have an inclination directed away from the contact structure (116), the inclination of the first profile side (142) being greater than the inclination of the second profile side (144).

4. The connecting part (100) according to claim 2 or 3, characterized in that the profile section (138) has substantially the shape of an oblique triangle.

5. The connecting part (100) according to any one of the claims 2 to 4, characterized in that the sealing groove (148) defines a first groove space (150) given by a recess formed in the contact carrier (114) and a second groove space (152) adjoining the first groove space (150) and widened with respect to the first groove space (150), wherein the sealing lip (132, 134) has a sealing seat (136) which is fixed in the first groove space (150), and the profile portion (138) of the sealing lip (132, 134) adjoining the sealing seat (136) is deformable in the widened second groove space (152).

6. The connecting part (100) according to any one of the preceding claims, characterized in that the sealing lip (132, 134) has a closed shape.

7. The connecting part (100) according to any one of the preceding claims, characterized in that the contact structure (116) comprises a plurality of contact elements (106, 108) enclosed by the at least one sealing lip (132, 134).

8. The connecting part (100) according to any one of the preceding claims, characterized in that the at least one sealing lip comprises a plurality of sealing lips (132, 134) each enclosing a part of the contact elements (106, 108).

9. The connecting part (100) according to claim 7 or 8, characterized in that the contact elements (106, 108) are designed as plug-in connection elements which can be brought into engagement in pairs with respectively associated plug-in connection elements (110) of the contact structure of the complementary connecting part (104).

10. The connecting part (100) according to claim 9, characterized in that the respective plug-in connection element (106, 108) is designed as a plug or socket.

11. The connecting part (100) according to any one of the preceding claims, characterized in that the sealing lip is made of an elastic plastic.

12. The connecting part (100) according to any one of the preceding claims, characterized by a biasing device configured to press the closure flap (128) onto the sealing lip (132, 134) when the plug-in connection is disconnected and to pivot the closure flap (128) away from the sealing lip (132, 134) in cooperation with the complementary connecting part (104) of the plug-in connection system (102) when the plug-in connection is established.

13. A plug-in connection system (102) for a coupling device for automatically coupling a trailer vehicle to a towing vehicle, comprising a first connecting part (100) according to any one of the preceding claims and a complementary second connecting part (104) having a contact structure engageable with the contact structure (116) of the first connecting part (100) to establish a plug-in connection with the first connecting part (100) during automatic coupling.
